(19) United States
(12) Patent Application Publication
(10) Pub. No.: US 2018/0375987 A1
(43) Pub. Date: Dec. 27, 2018

(54) METHOD, APPARATUS AND MOBILE TERMINAL FOR DEVICE CONTROL BASED ON A MOBILE TERMINAL

(71) Applicant: Alibaba Group Holding Limited, Grand Cayman (KY)

(72) Inventors: Didi Yao, Hangzhou (CN); Lei Zhang, Hangzhou (CN); Wuping Du, Hangzhou (CN)

(73) Assignee: Alibaba Group Holding Limited

(21) Appl. No.: 16/119,730

(22) Filed: Aug. 31, 2018

Related U.S. Application Data
(63) Continuation of application No. PCT/CN2017/074168, filed on Feb. 20, 2017.

(30) Foreign Application Priority Data
Mar. 1, 2016 (CN) 201610115087.6

(51) Int. Cl. H04M 1/725; H04W 76/14

(52) U.S. Cl. CPC H04M 1/72533; H04W 76/14

(57) ABSTRACT

The present disclosure sets forth a device control method, apparatus and mobile terminal based on a mobile device, wherein, a device control method based on a mobile device includes the below steps: establishing a communication connection with a controlled device; obtaining picture information currently displayed on the controlled device, generating a projected picture based on the picture information, and performing displaying; receiving a control operation of a user targeting the projected picture; converting the control operation to an instruction recognizable by the controlled device, and transmitting the instruction to the controlled device, to control the controlled device. A device control method based on a mobile terminal according to the present disclosure realizes inter-device complementary advantages, and greatly improves freedom and flexibility of user interactions.

### CROSS REFERENCE TO RELATED PATENT APPLICATIONS

This application claims priority and is a continuation of PCT Patent Application No. PCT/CN2017/074168, filed on Feb. 20, 2017, which claims priority to Chinese Patent Application No. 201610115087.6, filed on Mar. 1, 2016 and entitled “METHOD, APPARATUS AND MOBILE TERMINAL FOR DEVICE CONTROL BASED ON A MOBILE TERMINAL”, which is incorporated herein by reference in its entirety.

### TECHNICAL FIELD

The present disclosure relates to the field of communication technology, and, more particularly, to methods, apparatuses and mobile devices for device control based on a mobile terminal.

### BACKGROUND

Smart devices have already increasingly broadly entered people's everyday lives, where a user may engage in audiovisual, entertainment, shopping and such various kinds of activities through smart set-top boxes, smart televisions, personal computers, projectors and such devices. These smart devices are most commonly controlled utilizing remote controls or mice, with a single method of operation, operation being inconvenient. Especially in inputting text, operating buttons or playing games and such settings, the inconvenience of operation becomes more evident.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure is designed to solve the above-mentioned technical problem to at least a certain extent.

To this end, a first objective of the present disclosure lies in setting forth a device control method based on a mobile terminal, realizing inter-device complementary advantages, and greatly improving freedom and flexibility of user interactions.

A second objective of the present disclosure lies in setting forth a device control apparatus based on a mobile terminal.

A third objective of the present disclosure lies in setting forth a mobile terminal.

To achieve the above-mentioned objectives, example embodiments based on a first aspect of the present disclosure set forth a device control method based on a mobile device, including the below steps: establishing a communication connection with a controlled device; obtaining picture information currently displayed on the controlled device, generating a projected picture based on the picture information, and performing displaying; receiving a control operation of a user targeting the projected picture; converting the control operation to an instruction recognizable by the controlled device, and transmitting the instruction to the controlled device, to enable controlling of the controlled device.

Device control methods based on a mobile terminal according to example embodiments of the present disclosure, through projecting the picture information currently displayed on the controlled device on the mobile terminal, convert a control operation targeting the projected picture to an instruction recognizable by the controlled device and transmit it to the controlled device to enable controlling of the controlled device, realizing collaborative operational control by the mobile device of the controlled device, fully making use of the advantages of good display experience of the controlled device, and natural operation and convenience of the mobile terminal, to convert the various, natural, convenient operations of the mobile terminal to instructions recognizable by the controlled device, then performing control, thereby a single-mode operated controlled device may be collaboratively controlled in various modes through a mobile terminal, realizing inter-device complementary advantages, and at the same time as bringing a “what you see is what you get” visual operation experience to users, while freedom and flexibility of interaction are also greatly improved.

Example embodiments based on a second aspect of the present disclosure provide a device control apparatus based on a mobile device, including: a communicating module, operative to establish a communication connection with a controlled device; an obtaining module, operative to obtain picture information currently displayed on the controlled device; a generating module, operative to generate a projected picture based on the picture information, and perform displaying; a first receiving module, operative to receive a control operation of a user targeting the projected picture; a converting module, operative to convert the control operation to an instruction recognizable by the controlled device; and a transmitting module, operative to transmit the instruction recognizable by the controlled device to the controlled device, to enable controlling of the controlled device.

Device control apparatuses based on a mobile terminal according to example embodiments of the present disclosure, through projecting the picture information currently displayed on the controlled device on the mobile terminal, convert a control operation targeting the projected picture to an instruction recognizable by the controlled device and transmit it to the controlled device to enable controlling of the controlled device, realizing collaborative operational control by the mobile device of the controlled device, fully making use of the advantages of good display experience of the controlled device, and the natural operation and convenience of the mobile terminal, to convert the various, natural, convenient operations of the mobile terminal to instructions recognizable by the controlled device, then performing control, thereby a single-mode operated controlled device may be collaboratively controlled in various modes through a mobile terminal, realizing inter-device complementary advantages, and at the same time as bringing a “what you see is what you get” visual operation experience to users, while freedom and flexibility of interaction are also greatly improved.

Example embodiments of a third aspect of the present disclosure provide a mobile terminal, including a device control apparatus based on a mobile terminal according to an example embodiment of the second aspect of the present disclosure.

A mobile terminal according to example embodiments of the present disclosure, through projecting the picture information currently displayed on the controlled device on the mobile terminal, converts a control operation targeting the projected picture to an instruction recognizable by the controlled device and transmits it to the controlled device to enable controlling of the controlled device, realizing collaborative operational control by the mobile device of the controlled device, fully making use of the advantages of good display experience of the controlled device, and the natural operation and convenience of the mobile terminal, to convert the various, natural, convenient operations of the mobile terminal to instructions recognizable by the controlled device, then performing control, thereby a single-mode operated controlled device may be collaboratively controlled in various modes through a mobile terminal, realizing inter-device complementary advantages, and at the same time as bringing a “what you see is what you get” visual operation experience to users, while freedom and flexibility of interaction are also greatly improved.

Additional aspects and advantages of the present disclosure are partially disclosed by the below description, and partially made clear by the below description, or understandable through implementations of the present disclosure.

### BRIEF DESCRIPTION OF THE DRAWINGS

The above-mentioned and/or additional aspects and advantages of the present disclosure shall be made clear and easy to understand by a combination of the below Figures and descriptions of example embodiments, wherein:

FIG. 1 is a flowchart of a device control method based on a mobile terminal according to an example embodiment of the present disclosure;

FIG. 2 is a flowchart of a device control method based on a mobile terminal according to another example embodiment of the present disclosure;

FIG. 3 is a diagram of instruction conversion according to an example embodiment of the present disclosure;

FIG. 4 is a flowchart of a device control method based on a mobile terminal according to another example embodiment of the present disclosure;

FIG. 5 is a diagram of a projected picture according to an example embodiment of the present disclosure;

FIG. 6 is a flowchart of a device control method based on a mobile terminal according to another example embodiment of the present disclosure;

FIG. 7 is a schematic of a device control apparatus based on a mobile terminal according to an example embodiment of the present disclosure;

FIG. 8 is a schematic of a device control apparatus based on a mobile terminal according to another example embodiment of the present disclosure;

FIG. 9 is a schematic of a device control apparatus based on a mobile terminal according to another example embodiment of the present disclosure;

FIG. 10 is a schematic of a device control apparatus based on a mobile terminal according to another example embodiment of the present disclosure.

### DETAILED DESCRIPTION

Example embodiments of the present disclosure are described below, some examples of the example embodiments being illustrated in the drawings, wherein, from start to end, same or similar labels signify the same or similar elements or components having the same or similar functions. The example embodiments described below referencing the drawings are exemplary, used to explain the present disclosure, and shall not be understood as limiting the present disclosure.

Since mobile terminals have natural and diverse user interaction modes, such as touch, voice, body sensing, and such control modes, and the advantage of ease of control, therefore, in order to solve the present problem of smart set top boxes, smart televisions, personal computers, projectors and such devices despite having the advantages of large screen displays or broadcasts and ease of viewing, yet having a single method of operation, and operation being inconvenient, example embodiments of the present disclosure propose a method and apparatus for controlling devices based on mobile terminals, which may combine the above-mentioned two kinds of device advantages, realizing the combination of the advantages of large screen displays and natural control, improving interaction experience during usage by a user.

The reference drawings below describe device control methods and apparatuses based on a mobile terminal according to example embodiments of the present disclosure.

It should be stated that, mobile terminals according to embodiments of the present disclosure may be mobile phones, tablet computers, smart wearable devices, personal digital assistants, and such mobile devices.

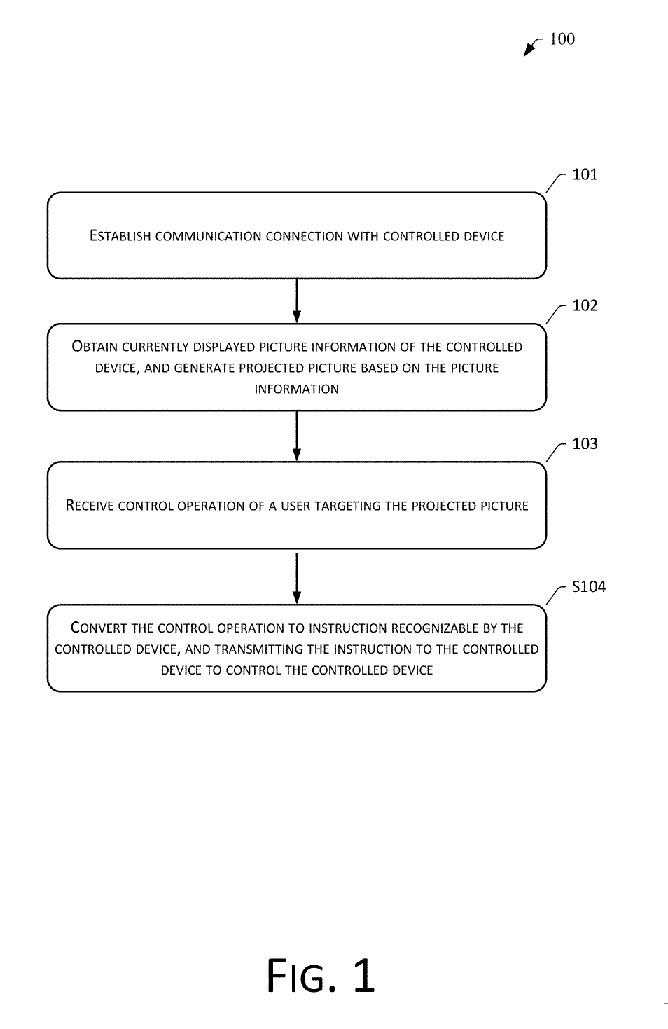

FIG. 1 illustrates a flowchart of a device control method 100 based on a mobile terminal according to an example embodiment of the present disclosure. As illustrated by FIG. 1, a device control method 100 based on a mobile terminal according to an example embodiment of the present disclosure includes:

Step 101, establishing a communication connection with a controlled device.

According to an example embodiment of the present disclosure, a controlled device may be a smart television, a television set top box, a personal computer, a projector, and the like.

Herein, a mobile terminal and a controlled device may establish a communication connection through, without limitation, Bluetooth, Wi-fi, 2.4G (a wireless communication protocol with frequency band between 2.400 GHz-2.4835 GHz), iBeacon (a wireless communication protocol released by Apple Inc. based on low power consumption Bluetooth), and such wireless communication protocols, or establish a communication connection through wired protocols.

Step 102, obtaining picture information currently displayed on the controlled device, generating a projected picture based on the picture information, and performing displaying.

According to an example embodiment of the present disclosure, a mobile terminal may obtain the picture information currently displayed on the controlled device through various methods. Two methods are described by way of example in the present disclosure below.

First Method

The controlled device transmits its displayed picture in real time to the mobile terminal.

Second Method

The controlled device provides the address of the data source of its displayed picture to the mobile terminal, and the mobile terminal may obtain the picture displayed by the controlled device in sync with the controlled device from the address of the data source.

It should be understood that the above-mentioned two methods are exemplary, and the present disclosure is not limited to realizing picture synchronization between the mobile terminal and the controlled device through the above-mentioned two methods, and other synchronization methods may also be included in the scope of the present disclosure.

According to an example embodiment of the present disclosure, differences in size exist between the display screens of the mobile terminal and the controlled device. Therefore, after the mobile device obtains the picture information currently displayed on the controlled device, the picture information may undergo size adjustment, to a display size adapted to the mobile terminal. In particular, generating a projected picture based on the picture information may include: based on the size of a preset display area, adjusting the size of the picture information, and generating the projected picture. Herein, the size of a preset display area may be determined based on the actual display area of the mobile terminal, for example, if it is a full-screen display, the size of the preset display area may be the screen size of the mobile terminal, and if it is a display within a particular window, the size of the preset display area may be the size of the window.

Step 103, receiving a control operation of a user targeting the projected picture.

When the user needs to perform an operation targeting picture information displayed by a controlled device, the user may directly operate the controlled device based on a projected picture displayed on the mobile terminal. Mobile terminals have various, diverse sensors and apparatuses, such as touchscreens, cameras, voice input apparatuses, gravity sensors, gyroscopes, accelerometers and such. Therefore, the mobile terminal may receive different forms of control operations. According to an embodiment of the present disclosure, the above-mentioned control operations may include at least one of the below:

A touch operation, a body sensing operation, a gesture operation, a voice operation.

By way of example, a user may input control operations by clicking on an operation control on a projected picture, or by inputting a voice instruction, or by shaking the control mobile terminal left and right in space, and such fashions.

Step 104, converting the control operation to an instruction recognizable by the controlled device, and transmitting the instruction to the controlled device, to control the controlled device.

In particular, instructions recognizable by the controlled device may be looked up based on identification information of the controlled device (such as a device serial number and the like) or designation of an application that displays the picture information on the controlled device (such as package name, name and the like).

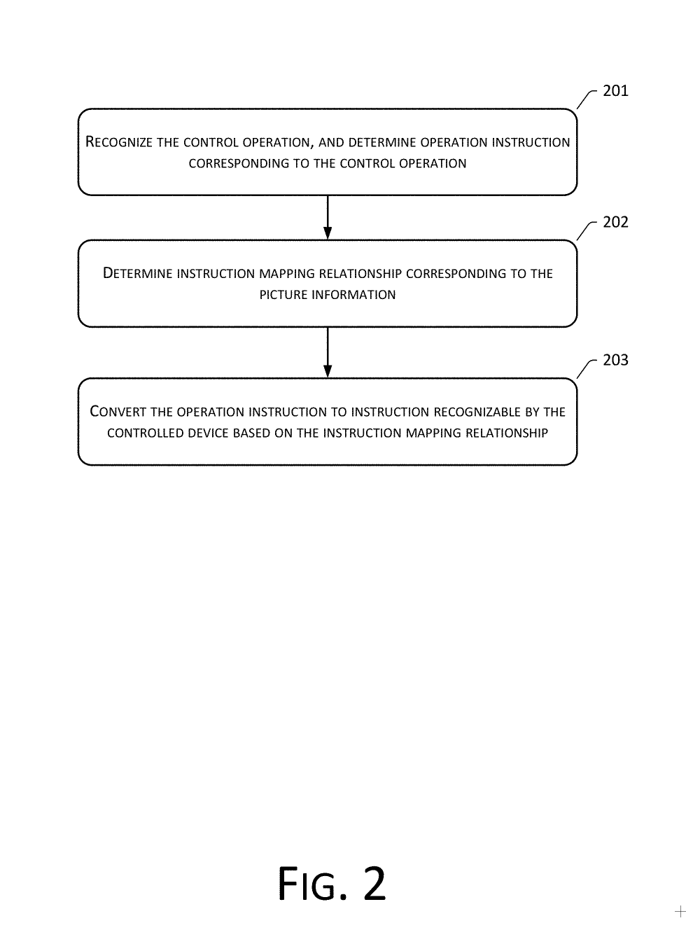

According to an example embodiment of the present disclosure, converting the control operation to the instruction recognizable by the controlled device may include steps 201 to 203 as illustrated by FIG. 2.

Step 201, recognizing the control operation, and determining an operation instruction corresponding to the control operation.

If the control operation is a touch operation, the touch operation may be recognized as an operation instruction which operates upon a corresponding operation control. By way of example, if the control operation touches the third control button of the projected picture, it may be recognized as “a click operation upon control button A.”

If the control operation is a voice operation, voice recognition may be performed upon the voice input by the user, resulting in an operation instruction upon a corresponding control.

If the control operation is a body sensing operation or gesture operation, the body sensing operation or gesture operation may be recognized as a button operation upon a corresponding button.

Step 202, determining an instruction mapping relationship corresponding to the picture information.

According to example embodiments of the present disclosure, based on identification information of the controlled device (such as device serial number and the like) a corresponding instruction mapping relationship may be looked up. Or, based on identification of an application that displays the picture information on the controlled device (such as package name, name and the like), a corresponding instruction mapping relationship may be looked up.

Herein, an instruction mapping relationship is a mapping relationship between an instruction of the mobile terminal and an instruction recognizable by the controlled device. Therefore, in view of the instruction mapping relationship an instruction recognizable by the controlled device corresponding to a recognized instruction may be looked up.

According to an example embodiment of the present disclosure, determining an instruction mapping relationship corresponding to the picture information may include: performing image recognition upon the picture information, and obtaining an identification of an application generating the picture information on the controlled device; querying a preset database based on the application identification, and obtaining a corresponding instruction mapping relationship.

According to an example embodiment of the present disclosure, the identification of a currently displayed application (that is, the application generating the picture information) may be obtained through a preset interface function from the system of the controlled device; or, through performing image recognition upon the picture information currently displayed on the controlled device, text information or icons from the currently displayed picture information may be obtained, and the corresponding application is determined from the obtained text information or icon.

Herein, instruction mapping relationships corresponding to different applications are stored in the preset database, which may be stored on the controlled device itself or on a server.

Step 203, converting the operation instruction to an instruction recognizable by the controlled device based on the instruction mapping relationship.

In particular, parsing, mapping and converting may be performed upon the above-mentioned operation instruction based on the instruction mapping relationship. By way of example, below are three examples of converting the operation instruction to an instruction recognizable by the controlled device based on the instruction mapping relationship.

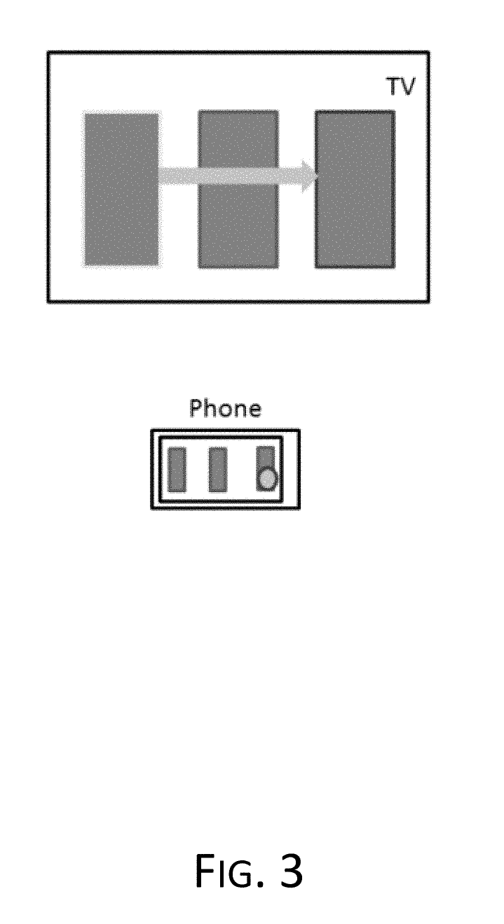

### Example One (Illustrated by FIG. 3)

Television manipulation method: no touch response, that is, it does not react to touch operations;

Operation instruction received by phone (mobile terminal): the third control button is touched;

Instruction parsed as: motion, clicking;

Instruction mapped to: first locating the present location of the control focus (the first control button), then moving the control focus from the present location to the third control button, and then clicking on the third control button;

Instruction converted to: right button (a directional button) twice, OK button once.

### Example Two

The present interface is a racing game interface, the manipulation method being a button response;

Operation instruction received by mobile terminal: a body sensing manipulation from GSensor (a gravity sensor);

Instruction parsed as: single-clicking or long-pressing, and the like, upon a directional button;

Instruction mapped to: first determining a direction corresponding to the body sensing operation, then clicking;

Instruction converted to: right button (a directional button), single-clicking or long-pressing.

### Example Three

The current interface is a game interface that may respond to touch operations;

Operation instruction received by mobile terminal: the third control button is touched;

Instruction parsed as: clicking;

Instruction mapped to: clicking;

Instruction converted to: clicking the third control button once.

According to an example embodiment of the present disclosure, after the controlled device responds to a recognizable instruction transmitted by the mobile terminal, the mobile terminal may produce a click prompt at the corresponding response location of the projected picture, or, may undergo a vibration prompt and the like, enhancing inter-device interactivity, and improving the user experience.

Additionally, since the mobile terminal obtains the picture information currently displayed on the controlled device, therefore, when a change occurs in the picture displayed by the controlled terminal, the projected picture on the mobile terminal also changes accordingly.

Device control methods based on a mobile terminal according to example embodiments of the present disclosure, through projecting the picture information currently displayed on the controlled device on the mobile terminal, convert a control operation targeting the projected picture to an instruction recognizable by the controlled device and transmit it to the controlled device, realizing collaborative operational control by the mobile device of the controlled device, fully making use of the advantages of good display experience of the controlled device, and natural operation and convenience of the mobile terminal, to convert the various, natural, convenient operations of the mobile terminal to instructions recognizable by the controlled device, then performing control, thereby a single-mode operated controlled device may be collaboratively controlled in various modes through a mobile terminal, realizing inter-device complementary advantages, and at the same time as bringing a “what you see is what you get” visual operation experience to users, while freedom and flexibility of interaction are also greatly improved.

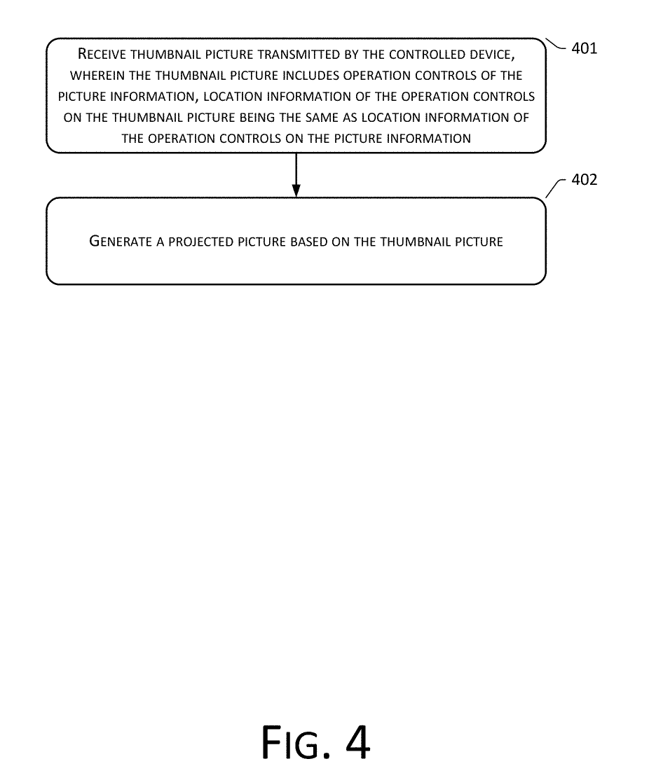

Further, to improve data transmission speed, a thumbnail picture that may be generated from the picture information currently displayed on the controlled device is further improved. In particular, according to another example embodiment of the present disclosure, the methods of the example embodiments of the present disclosure further include steps 401 to 402 as illustrated by FIG. 4. Herein,

Step 401, receiving a thumbnail picture transmitted by the controlled device, wherein, the thumbnail picture includes operation controls of the picture information, location information of the operation controls on the thumbnail picture being the same as location information of the operation controls on the picture information.

Herein, the thumbnail picture may have backgrounds, images, and such extraneous information removed from the picture currently displayed on the controlled device. The thumbnail picture retains only operation controls on the currently displayed picture as well as location information among operation controls.

Step 402, generating a projected picture based on the thumbnail picture.

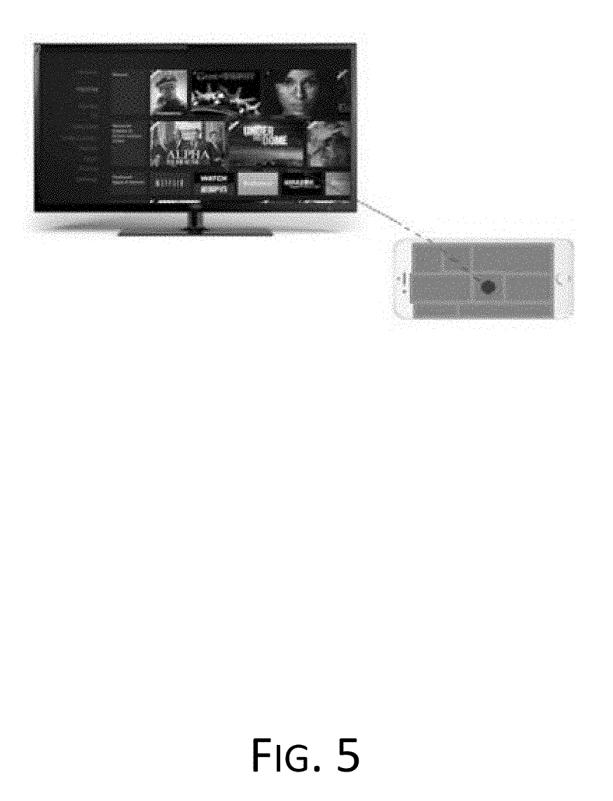

By way of example, as illustrated by FIG. 5, a displayed picture on a television may be projected as a thumbnail projected picture in a frame format on a mobile phone.

Device control methods based on mobile terminals according to example embodiments of the present disclosure, generate thumbnail pictures based on pictures currently displayed on controlled devices, then transfer to mobile terminals and generate projected pictures, greatly reducing quantities of data transferred in the interaction process, improving transfer efficiency, and by effectively improving interaction and response times, offer a user smooth, fast experiences.

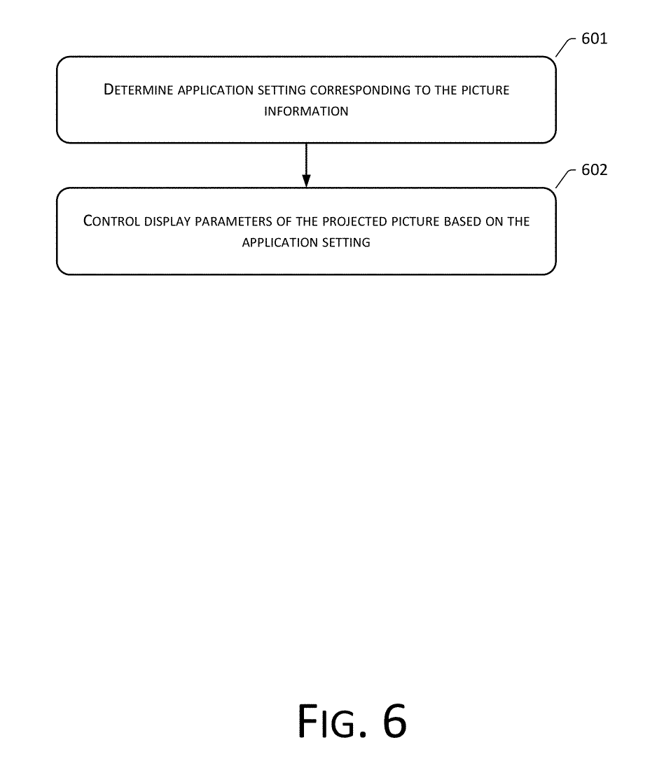

According to an example embodiment of the present disclosure, as illustrated by FIG. 6, steps 601 to 602 may be further included. Herein:

Step 601, determining an application setting corresponding to the picture information.

By way of example, an application setting may include an ongoing game setting, a main interface setting, a video playback setting, and the like.

According to an example embodiment of the present disclosure, based on the type to which the application generating the picture information belongs, the application setting corresponding to the picture information may be determined. By way of example, if the application generating the picture information is a game-type application, the application setting corresponding to the picture information is an ongoing game setting; if the application generating the picture information is a video playback-type application, the application setting corresponding to the picture information is a video playback setting.

Further, application settings corresponding to different picture information may be sorted in a more streamlined fashion. In particular, on the basis of determining the application generating the picture information, the picture information may further undergo image recognition, thus determining the content of the picture information, and the corresponding application setting is determined based on the content of the picture information. By way of example, if the content of the picture information is a main interface or a menu interface of an application or device, the application setting corresponding to the picture information is a main interface setting; if the content of the picture information is an interface of a running game program, the application setting corresponding to the picture information is an ongoing game setting.

Step 602, controlling display parameters of the projected picture based on the application setting.

According to an example embodiment of the present disclosure, display parameters may include smoothness and/or resolution.

By way of example, with regard to a main interface of an application or device, when update frequency is relatively low in the display process, or interface changes only occur when a user performs an operation, smoothness may be appropriately reduced, such as a frame rate setting of 20 fps (frames per second); or, with regard to a game setting, or a video playback setting, the picture is dynamically changing, and the smoothness may be appropriately increased, such as a frame rate setting of 30 fps (frames per second).

With regard to resolution, it may also be adjusted according to the display requirements of actual settings.

Therefore, display parameters of a projected picture may be dynamically adjusted based on the application setting corresponding to the picture information of the controlled device, offering good visual experiences for users and, at the same time, reducing device power consumption.

Corresponding to the device control methods based on a mobile terminal provided by the above-mentioned example embodiments, the present disclosure further sets forth a device control apparatus based on a mobile terminal.

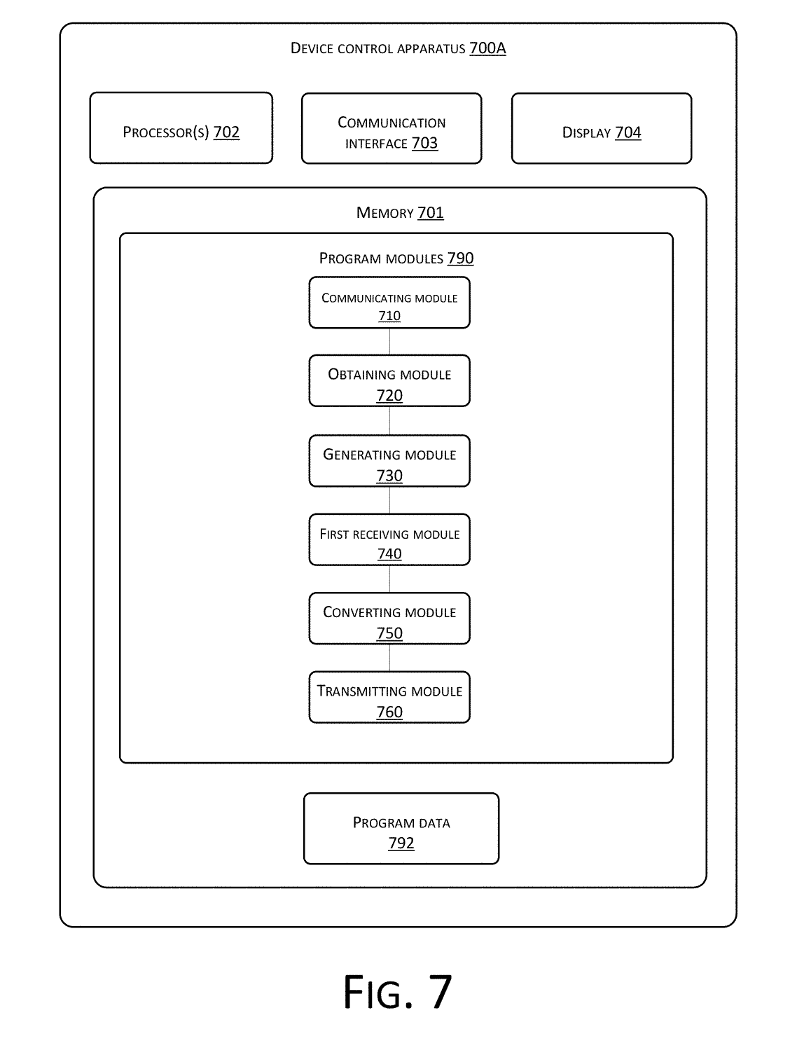

FIG. 7 is a schematic of a device control apparatus 700A based on a mobile terminal according to an example embodiment of the present disclosure.

As illustrated by FIG. 7, a device control apparatus 700A based on a mobile terminal according to example embodiments of the present disclosure includes: memory 701, one or more processors 702, a communication interface 703, and a display 704. The device control apparatus 700A may further include a communicating module 710, an obtaining module 720, a generating module 730, a first receiving module 740, a converting module 750 and a transmitting module 760.

Memory 701 is operative to store program instructions and/or data.

One or more processors 702, through reading program instructions and/or data stored on memory 701, is operative to execute processes as follows:

In particular, the communicating module 710 is stored in the memory 701 and executable by the one or more processors 702 to cause the communication interface 703 to establish a communication connection with a controlled device.

According to an example embodiment of the present disclosure, the controlled device may be a smart television, a television set top box, a personal computer, a projector, and the like.

Herein, the communicating module 710 may be executable by the one or more processors 702 to cause the communication interface 703 to establish a connection with the controlled device through, without limitation, Bluetooth, Wi-fi, 2.4G (a wireless communication protocol with frequency band between 2.400 GHz-2.4835 GHz), iBeacon (a wireless communication protocol released by Apple Inc. based on low power consumption Bluetooth), and such wireless communication protocols, or establish a communication connection through wired protocols.

The obtaining module 720 is stored in the memory 701 and executable by the one or more processors 702 to cause the communication interface 703 to obtain picture information currently displayed on the controlled device.

According to example embodiments of the present disclosure, the obtaining module 720 may be executable by the one or more processors 702 to cause the communication interface 703 to obtain the picture information currently displayed on the controlled device by various different methods. Two methods are described by way of example in the present disclosure below.

First Method

The controlled device transmits its displayed picture in real time to the communication interface 703.

Second Method

The controlled device provides the address of the data source of its displayed picture to the communication interface 703, and the communication interface 703 may obtain the picture displayed by the controlled device in sync with the controlled device from the address of the data source.

It should be understood that the above-mentioned two methods are exemplary, and the present disclosure is not limited to realizing picture synchronization between the communication interface 703 and the controlled device through the above-mentioned two methods, and other synchronization methods may also be included in the scope of the present disclosure.

The generating module 730 is stored in the memory 701 and executable by the one or more processors 702 to cause the one or more processors 702 to generate a projected picture based on the picture information, and cause the display 704 to perform displaying.

According to an example embodiment of the present disclosure, differences in size exist between the display screens of the mobile terminal and the controlled device. Therefore, after the obtaining module 720 causes the communication interface 703 to obtain the picture information currently displayed on the controlled device, the generating module 730 may cause the one or more processors 702 to perform size adjustment upon the picture information, to a display size adapted to the mobile terminal. In particular, the generating module 730 may be executable by the one or more processors 702 to cause the one or more processors 702 to: based on the size of a preset display area, adjust the size of the picture information, and generate the projected picture. Herein, the size of a preset display area may be determined based on the actual display area of the mobile terminal, for example, if it is a full-screen display, the size of the preset display area may be the screen size of the mobile terminal, and if it is a display within a particular window, the size of the preset area may be the size of the window.

The first receiving module 740 is stored in the memory 701 and executable by the one or more processors 702 to cause the communication interface 703 to receive a control operation of a user targeting the projected picture.

When the user needs to perform an operation targeting picture information displayed by a controlled device, the user may directly operate the controlled device based on a projected picture displayed on the mobile terminal. Mobile terminals have various, diverse sensors and apparatuses, such as touchscreens, cameras, voice input apparatuses, gravity sensors, gyroscopes, accelerometers and such. Therefore, the first receiving module 740 may cause the communication interface 703 to receive different modes of control operations. According to an embodiment of the present disclosure, the above-mentioned control operations may include at least one of the below:

A touch operation, a body sensing operation, a gesture operation, a voice operation.

By way of example, a user may input control operations by clicking on an operation control on a projected picture, or by inputting a voice instruction, or by shaking the control mobile terminal left and right in space, and such modes.

The converting module 750 is stored in the memory 701 and executable by the one or more processors 702 to cause the one or more processors 702 to convert the control operation to an instruction recognizable by the controlled device.

In particular, the converting module 750 may cause the one or more processors 702 to look up instructions recognizable by the controlled device based on identification information of the controlled device (such as a device serial number and the like) or designation of an application that displays the picture information on the controlled device (such as package name, name and the like).

An embodiment of the present application further discloses a computer readable storage medium, wherein the computer readable storage medium stores instructions which, when running on a computer, enable the computer to perform the processes described above.

The memory 701 may include a form of computer readable media such as a volatile memory, a random access memory (RAM) and/or a non-volatile memory, for example, a read-only memory (ROM) or a flash RAM. The memory 702 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 701 may include program modules 790 and program data 792. The program modules 790 may include one or more of the modules as described in above.

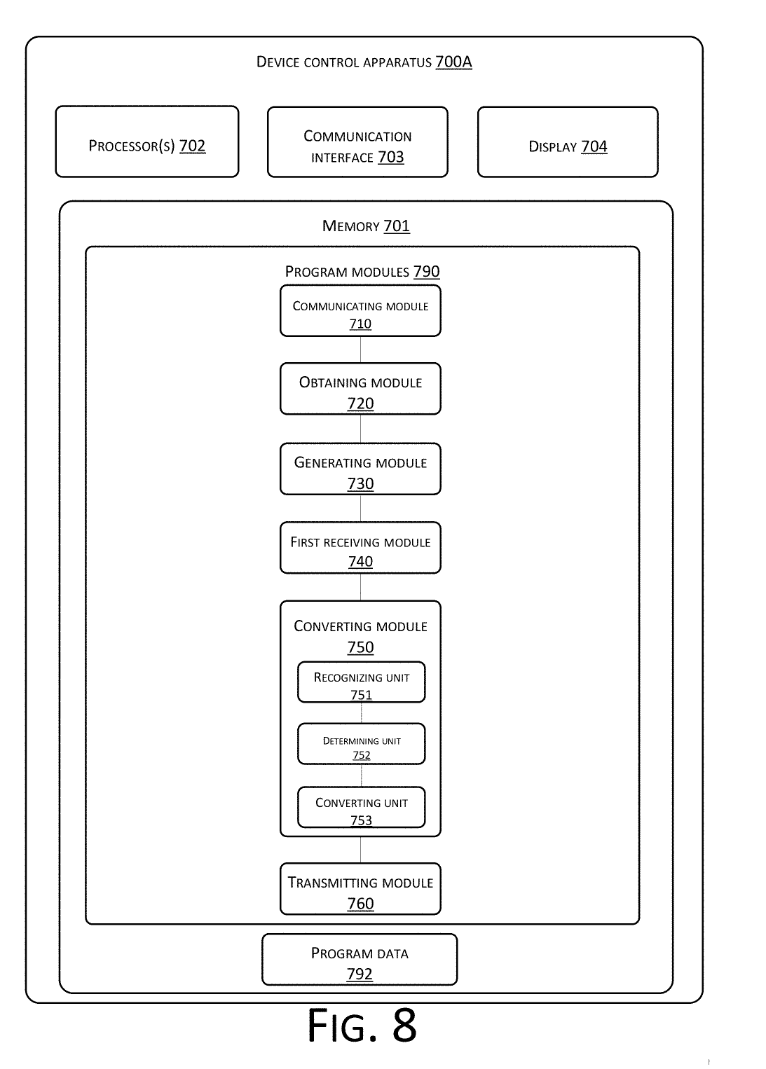

According to an example embodiment of the present disclosure, as illustrated by FIG. 8, the converting module 750 may further include: a recognizing unit 751, a determining unit 752 and a converting unit 753.

Herein, the recognizing unit 751 is stored in the memory 701 and executable by the one or more processors 702 to cause the one or more processors 702 to recognize the control operation, and determine an operation instruction corresponding to the control operation.

If the control operation is a touch operation, the recognizing unit 751 may cause the one or more processors 702 to recognize the touch operation as an operation instruction which operates upon a corresponding operation control. By way of example, if the control operation touches the third control button A of the projected picture, it may be recognized as “a click operation upon control button A.”

If the control operation is a voice operation, the recognizing unit 751 may cause the one or more processors 702 to perform voice recognition upon the voice input by the user, resulting in an operation instruction upon a corresponding control.

If the control operation is a body sensing operation or gesture operation, the recognizing unit 751 may cause the one or more processors 702 to recognize the body sensing operation or gesture operation as a button operation upon a corresponding button.

The determining unit 752 is stored in the memory 701 and executable by the one or more processors 702 to cause the one or more processors 702 to determine an instruction mapping relationship corresponding to the picture information.

According to example embodiments of the present disclosure, the determining unit 752 may cause the one or more processors 702 to, based on identification information of the controlled device (such as device serial number and the like), look up a corresponding instruction mapping relationship. Or, the determining unit 752 may cause the one or more processors 702 to, based on identification of an application that displays the picture information on the controlled device (such as package name, name and the like), look up a corresponding instruction mapping relationship.

Herein, an instruction mapping relationship is a mapping relationship between an instruction of the mobile terminal and an instruction recognizable by the controlled device. Therefore, in view of the instruction mapping relationship an instruction recognizable by the controlled device corresponding to a recognized instruction may be looked up.

According to an example embodiment of the present disclosure, the determining unit 752 may cause the one or more processors 702 to: perform image recognition upon the picture information, and obtain an identification of an application generating the picture information on the controlled device; query a preset database based on the application identification, and obtain a corresponding instruction mapping relationship.

According to an example embodiment of the present disclosure, the identification of a currently displayed application (that is, the application generating the picture information) may be obtained through a preset interface function from the system of the controlled device; or, through performing image recognition upon the picture information currently displayed on the controlled device, text information or icons from the currently displayed picture information may be obtained, and the corresponding application is determined from the obtained text information or icon.

Herein, instruction mapping relationships corresponding to different applications are stored in the preset database, which may be stored on the controlled device itself or on a server.

The converting unit 753 is stored in the memory 701 and executable by the one or more processors 702 to cause the one or more processors 702 to convert the operation instruction to an instruction recognizable by the controlled device based on the instruction mapping relationship.

In particular, the converting unit 753 may perform parsing, mapping and converting upon the above-mentioned operation instruction based on the instruction mapping relationship. By way of example, below are three examples of converting the operation instruction to an instruction recognizable by the controlled device based on the instruction mapping relationship.

### Example One (Illustrated by FIG. 3)

Television manipulation method: no touch response, that is, it does not react to touch operations;

Operation instruction received by phone (mobile terminal): the third control button is touched;

Instruction parsed as: motion, clicking;

Instruction mapped to: first locating the present location of the control focus (the first control button), then moving the control focus from the present location to the third control button, and then clicking on the third control button;

Instruction converted to: right button (a directional button) twice, OK button once.

### Example Two

The present interface is a racing game interface, the manipulation method being a button response;

Operation instruction received by mobile terminal: a body sensing manipulation from GSensor (a gravity sensor);

Instruction parsed as: single-clicking or long-pressing, and the like, upon a directional button;

Instruction mapped to: first determining a direction corresponding to the body sensing operation, then clicking;

Instruction converted to: right button (a directional button), single-clicking or long-pressing.

### Example Three

The current interface is a game interface that may respond to touch operations;

Operation instruction received by mobile terminal: the third control button is touched;

Instruction parsed as: clicking;

Instruction mapped to: clicking;

Instruction converted to: clicking the third control button once.

The transmitting module 760 is stored in the memory 701 and executable by the one or more processors 702 to cause the communication interface 703 to transmit the instruction recognizable by the controlled device to the controlled device, to control the controlled device.

According to an example embodiment of the present disclosure, after the controlled device receives a recognizable instruction transmitted by the communication interface 703 caused by the transmitting module 760, it may perform responding. At this time, the mobile terminal may produce a click prompt at the corresponding response location of the projected picture, or, may undergo a vibration prompt and the like, enhancing inter-device interactivity, and improving the user experience.

Additionally, since the mobile terminal obtains the picture information currently displayed on the controlled device, therefore, when a change occurs in the picture displayed by the controlled terminal, the projected picture on the mobile terminal also changes accordingly.

Device control apparatuses based on a mobile terminal according to example embodiments of the present disclosure, through projecting the picture information currently displayed on the controlled device on the mobile terminal, convert a control operation targeting the projected picture to an instruction recognizable by the controlled device and transmit it to the controlled device to control the controlled device, realizing collaborative operational control by the mobile device of the controlled device, fully making use of the advantages of good display experience of the controlled device, and the natural operation and convenience of the mobile terminal, to convert the various, natural, convenient operations of the mobile terminal to instructions recognizable by the controlled device, then performing control, thereby a single-mode operated controlled device may be collaboratively controlled in various modes through a mobile terminal, realizing inter-device complementary advantages, and at the same time as bringing a “what you see is what you get” visual operation experience to users, while freedom and flexibility of interaction are also greatly improved.

An embodiment of the present application further discloses a computer readable storage medium, wherein the computer readable storage medium stores instructions which, when running on a computer, enable the computer to perform the processes described above.

The memory 701 may include a form of computer readable media such as a volatile memory, a random access memory (RAM) and/or a non-volatile memory, for example, a read-only memory (ROM) or a flash RAM. The memory 702 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 701 may include program modules 790 and program data 792. The program modules 790 may include one or more of the modules as described in above.

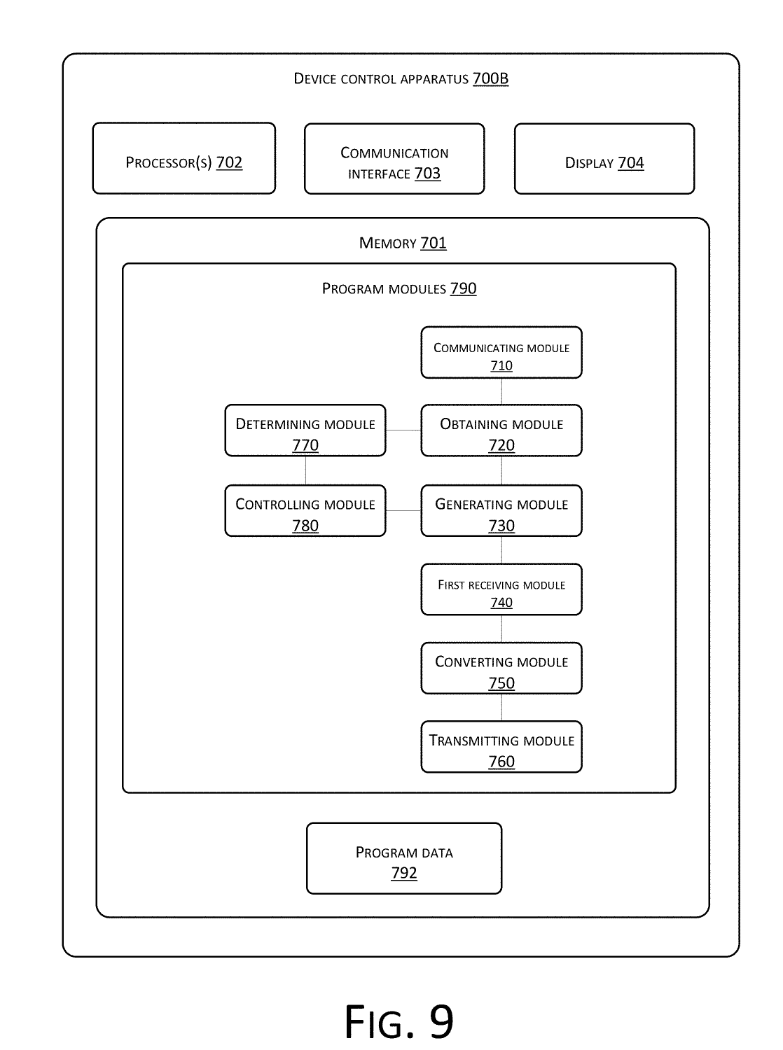

FIG. 9 is a schematic of a device control apparatus 700B based on a mobile terminal according to another example embodiment of the present disclosure.

As illustrated by FIG. 9, the device control apparatus 700B based on a mobile terminal according to an example embodiment of the present disclosure includes: a communicating module 710, an obtaining module 720, a generating module 730, a first receiving module 740, a converting module 750, a transmitting module 760, a determining module 770 and a controlling module 780.

Herein, the communicating module 710, the obtaining module 720, the generating module 730, the first receiving module 740, the converting module 750 and the transmitting module 760 are the same as corresponding elements in the example embodiment illustrated by FIG. 7.

The determining module 770 is stored in the memory 701 and executable by the one or more processors 702 to cause the one or more processors 702 to determine an application setting corresponding to the picture information.

By way of example, an application setting may include an ongoing game setting, a main interface setting, a video playback setting, and the like.

According to an example embodiment of the present disclosure, the determining module 770 may cause the one or more processors 702 to, based on the type to which the application generating the picture information belongs, determine the application setting corresponding to the picture information. By way of example, if the application generating the picture information is a game-type application, the application setting corresponding to the picture information is an ongoing game setting; if the application generating the picture information is a video playback-type application, the application setting corresponding to the picture information is a video playback setting.

Further, the determining module 770 may cause the one or more processors 702 to sort application settings corresponding to different picture information in a more streamlined fashion. In particular, on the basis of determining the application generating the picture information, the determining module 770 may cause the one or more processors 702 to perform image recognition upon the picture information, thus determining the content of the picture information, and the corresponding application setting is determined based on the content of the picture information. By way of example, if the content of the picture information is an application or device main interface or a menu interface, the application setting corresponding to the picture information is a main interface setting; if the content of the picture information is an interface of a running game program, the application setting corresponding to the picture information is an ongoing game setting.

The controlling module 780 is stored in the memory 701 and executable by the one or more processors 702 to cause the one or more processors 702 to control display parameters of the projected picture based on the application setting.

According to an example embodiment of the present disclosure, display parameters may include smoothness and/or resolution.

By way of example, with regard to a main interface of an application or device, when update frequency is relatively low in the display process, or interface changes only occur when a user performs an operation, the controlling module 780 may cause the one or more processors 702 to appropriately reduce smoothness, such as a frame rate setting of 20 fps (frames per second); or, with regard to a game setting, or a video playback setting, the picture is dynamically changing, and the controlling module 780 may appropriately increase smoothness, such as a frame rate setting of 30 fps (frames per second).

With regard to resolution, the controlling module 780 may cause the one or more processors 702 to perform adjustment thereto according to the display requirements of actual settings.

Therefore, display parameters of a projected picture may be dynamically adjusted based on the application setting corresponding to the picture information of the controlled device, offering good visual experiences for users and, at the same time, reducing device power consumption.

An embodiment of the present application further discloses a computer readable storage medium, wherein the computer readable storage medium stores instructions which, when running on a computer, enable the computer to perform the processes described above.

The memory 701 may include a form of computer readable media such as a volatile memory, a random access memory (RAM) and/or a non-volatile memory, for example, a read-only memory (ROM) or a flash RAM. The memory 702 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 701 may include program modules 790 and program data 792. The program modules 790 may include one or more of the modules as described in above.

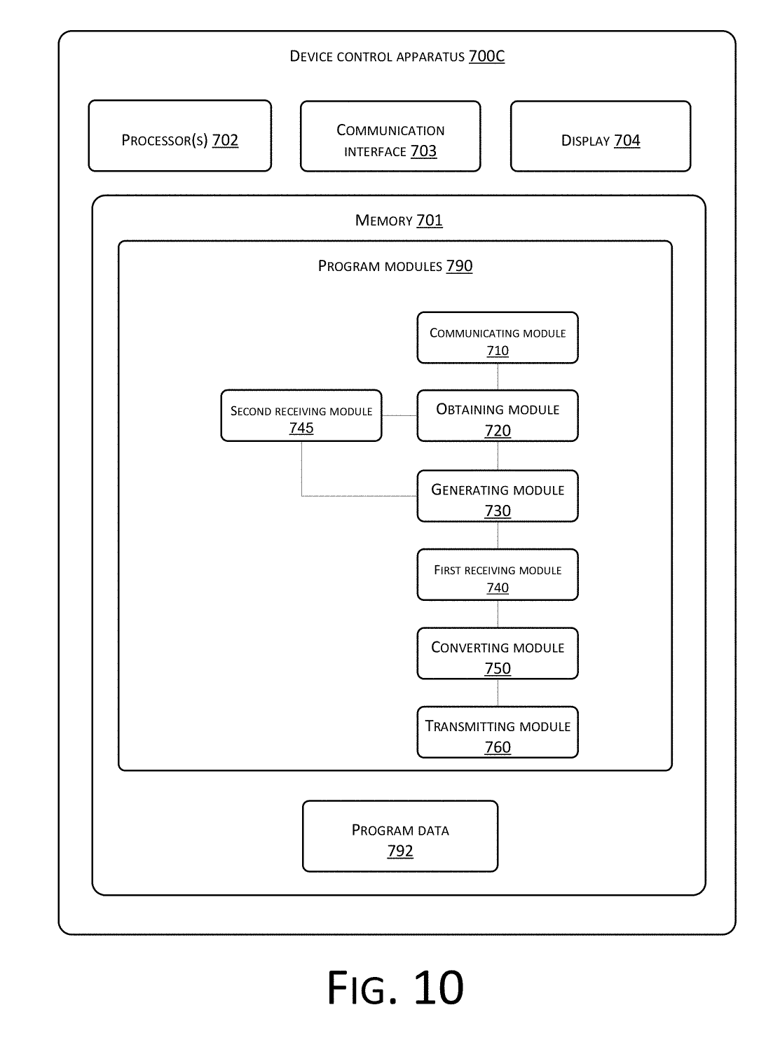

FIG. 10 is a schematic of a device control apparatus 700C based on a mobile terminal according to another example embodiment of the present disclosure.

As illustrated by FIG. 10, the device control apparatus 700C based on a mobile terminal according to an example embodiment of the present disclosure includes: a communicating module 710, an obtaining module 720, a generating module 730, a first receiving module 740, a conversion module 750, a transmitting module 760 and a second receiving module 745.

Herein, the communicating module 710, the obtaining module 720, the generating module 730, the first receiving module 740, the conversion module 750 and the transmitting module 760 are the same as in the example embodiment illustrated by FIG. 7.

The second receiving module 745 is stored in the memory 701 and executable by the one or more processors 702 to cause the communication interface 703 to receive a thumbnail picture transmitted by the controlled device, wherein, the thumbnail picture includes operation controls of the picture information, location information of the operation controls on the thumbnail picture being the same as location information of the operation controls on the picture information.

Herein, the thumbnail picture may have backgrounds, images, and such extraneous information removed from the picture currently displayed on the controlled device. The thumbnail picture retains only operation controls on the currently displayed picture as well as location information among the operation controls.

Herein, the generating module 730 is further executable by the one or more processors 702 to cause the one or more processors 702 to generate a projected picture based on the thumbnail picture.

By way of example, as illustrated by FIG. 5, a displayed picture on a television may be projected as a thumbnail projected picture in a frame format on a mobile phone.

Device control methods based on mobile terminals according to example embodiments of the present disclosure, generating thumbnail pictures based on pictures currently displayed on controlled devices, then transferring to mobile terminals and generating projected pictures, greatly reduce quantities of data transferred in the interaction process, improving transfer efficiency, and by effectively improving interaction and response times, offer a user smooth, fast experiences.

An embodiment of the present application further discloses a computer readable storage medium, wherein the computer readable storage medium stores instructions which, when running on a computer, enable the computer to perform the processes described above.

The memory 701 may include a form of computer readable media such as a volatile memory, a random access memory (RAM) and/or a non-volatile memory, for example, a read-only memory (ROM) or a flash RAM. The memory 701 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 701 may include program modules 790 and program data 792. The program modules 790 may include one or more of the modules as described in above.

The present disclosure further sets forth a mobile terminal.

A mobile terminal according to example embodiments of the present disclosure includes: a device control apparatus based on a mobile terminal according to an example embodiment of the present disclosure.

A mobile terminal according to example embodiments of the present disclosure, through projecting the picture information currently displayed on the controlled device on the mobile terminal, converts a control operation targeting the projected picture to an instruction recognizable by the controlled device and transmits it to the controlled device to control the controlled device, realizing collaborative operational control by the mobile device of the controlled device, fully making use of the advantages of good display experience of the controlled device, and the natural operation and convenience of the mobile terminal, to convert the various, natural, convenient operations of the mobile terminal to instructions recognizable by the controlled device, then performing control, thereby a single-mode operated controlled device may be collaboratively controlled in various modes through a mobile terminal, realizing inter-device complementary advantages, and at the same time as bringing a “what you see is what you get” visual operation experience to users, while freedom and flexibility of interaction are also greatly improved.

Any processes or methods described in flowcharts or by any other methods may be understood as indicating including one or more code modules, components or parts capable of executing instructions operative to implement specific logical functions or steps of processes, and the scope of preferred embodiments of the present disclosure includes other implementations, which may not be according to the illustrated or discussed order, and functions may be executed in a fashion essentially at the same time based on related functions or in a reversed order, as will be understood by persons skilled in the technical field from the example embodiments of the present disclosure.

Logic and/or steps as indicated by flowcharts, or as described by any other methods, may be thought of as sequence listings capable of executing instructions operative to implement the logical functions, which may in particular be implemented in any computer-readable medium, used by instruction-executing systems, apparatuses or devices (as based on computer systems, systems including processors or other systems capable of obtaining instructions and executing instructions from systems, apparatuses or devices executing instructions), or used by these instruction-execution systems apparatuses or devices in combination. For the purpose of this specification, a “computer-readable medium” may be any instruction-executing system, apparatus or device capable of including, storing, communicating, transmitting or transferring programs or a combination of these instruction-executing systems, apparatuses or devices or apparatuses using such. Particular examples (listed non-exhaustively) of computer-readable media include the following: electrical connections having one or more wires (electronic devices), portable computer disk boxes (magnetic devices), random-access memory (RAM), read-only memory (ROM), electronically erasable programmable read-only memory (EPROM or flash memory), fiber optic devices, compact disc read-only memory (CDROM). Additionally, computer-readable media may even be paper on which programs may be printed or other suitable media, since, for example, by optical scanning of paper or other media, then processing by editing, interpreting or other suitable methods as needed, the programs may be electronically obtained, then stored on a computer memory.

It should be understood that each part of the present disclosure may be implemented on hardware, software, firmware or a combination thereof. By the above-mentioned implementations, multiple steps or methods may be implemented by software executable by an instruction-executing system stored on a memory. For example, if implemented using hardware, just as by another implementation, any item among the below-mentioned techniques known in the art or combination thereof may be used for implementation: discrete logic circuits of logic gates having the capability of implementing logical functions of data signals, application-specific integrated circuits having suitable combinational logic gates, programmable gate arrays (PGAs), field-programmable gate arrays (FPGAs), and the like.

It may be understood by persons of ordinary skill in the technical field that all or some steps carried by the above-mentioned example embodiments may be implemented by programs instructing related hardware, where the programs may be stored on a same kind of computer-readable storage medium, and upon execution of the programs, including one or a combination of the steps of the method example embodiments.

Additionally, functional units according to example embodiments of the present disclosure may be integrated into one processing module, or may exist as individual separate physical modules, or two or more than two units may be integrated into one module. The above-mentioned integration of modules may be implemented using the form of hardware, or may be implemented using the form of software function modules. The integration of modules, if implemented by the form of software functional modules and sold or used as individual products, may also be stored on a computer-readable medium.

The above-mentioned computer-readable storage medium may be a read-only memory, magnetic disk or optical disc and the like.

As described in the present specification, the descriptive meanings of reference terms “an example embodiment,” “some example embodiments,” “examples,” “particular examples,” or “some examples” and the like combine the particular characteristics, structures, materials, or features of the example embodiments or examples contained in at least one example embodiment or example of the present disclosure. According to the present specification, the descriptive intent of the above-mentioned language does not necessarily mean a same example embodiment or example. As well, particular characteristics, structures, materials, or features as described may be combined in suitable fashions in any one or more than one example embodiment or example.

Although the example embodiments of the present disclosure have already been illustrated and described, it may be understood by persons of ordinary skill in the art that: where not departing from the principles and purposes of the present disclosure, these example embodiments may be modified, revised, replaced and varied in various ways, the scope of the claims of the present disclosure to include such equivalents.

The present disclosure may further be understood with clauses as follows.

1. A device control method based on a mobile terminal, comprising:

establishing a communication connection with a controlled device;

obtaining picture information currently displayed on the controlled device, generating a projected picture based on the picture information, and performing displaying;

receiving a control operation of a user targeting the projected picture; and

converting the control operation to an instruction recognizable by the controlled device, and transmitting the instruction to the controlled device, to control the controlled device.

2. The method of clause 1, wherein converting the control operation to an instruction recognizable by the controlled device comprises:

recognizing the control operation, and determining an operation instruction corresponding to the control operation;

determining an instruction mapping relationship corresponding to the picture information;

converting the operation instruction to an instruction recognizable by the controlled device based on the instruction mapping relationship.

3. The method of clause 2, wherein determining an instruction mapping relationship corresponding to the picture information comprises:

obtaining an identification of an application generating the picture information on the controlled device; and

querying a preset database based on the application identification, and obtaining a corresponding instruction mapping relationship.

4. The method of clause 1, further comprising:

determining an application setting corresponding to the picture information; and

controlling display parameters of the projected picture based on the application setting.

5. The method of clause 4, wherein the display parameters comprise smoothness and/or resolution.

6. The method of clause 1, wherein generating a projected picture based on the picture information comprises:

adjusting the size of the picture information based on the size of a preset display area, and generating the projected picture.

7. The method of clause 1, further comprising:

receiving a thumbnail picture transmitted by the controlled device, wherein the thumbnail picture includes operation controls of the picture information, location information of the operation controls on the thumbnail picture being the same as location information of the operation controls on the picture information; and

generating a projected picture based on the thumbnail picture.

8. The method of clause 1, wherein the control operation comprises at least one of:

a touch operation, a body sensing operation, a gesture operation, and a voice operation.

9. The method of one of the clauses 1 to 8, wherein the controlled device is a smart television, a television set top box, a personal computer, or a projector.

10. A device control apparatus based on a mobile terminal, comprising:

a communicating module, operative to establish a communication connection with a controlled device;

an obtaining module, operative to obtain picture information currently displayed on the controlled device;

a generating module, operative to generate a projected picture based on the picture information, and perform displaying;

a first receiving module, operative to receive a control operation of a user targeting the projected picture;

a converting module, operative to convert the control operation to an instruction recognizable by the controlled device; and

a transmitting module, operative to transmit the instruction recognizable by the controlled device to the controlled device, to control the controlled device.

11. The apparatus of clause 10, wherein the converting module further comprises:

a recognizing unit, operative to recognize the control operation, and determine an operation instruction corresponding to the control operation;

a determining unit, operative to determine an instruction mapping relationship corresponding to the picture information; and

a converting unit, operative to convert the operation instruction to an instruction recognizable by the controlled device based on the instruction mapping relationship.

12. The apparatus of clause 11, wherein the determining unit is further operative to:

obtain an identification of an application generating the picture information on the controlled device; and

query a preset database based on the application identification, and obtain a corresponding instruction mapping relationship.

13. The apparatus of clause 10, further comprising:

a determining module, operative to determine an application setting corresponding to the picture information; and

a controlling module, operative to control display parameters of the projected picture based on the application setting.

14. The apparatus of clause 13, wherein the display parameters comprise smoothness and/or resolution.

15. The apparatus of clause 10, wherein the generating module is further operative to:

adjust the size of the picture information based on the size of a preset display area, and generate the projected picture.

16. The apparatus of clause 10, further comprising:

a second receiving module, operative to receive a thumbnail picture transmitted by the controlled device, wherein the thumbnail picture includes operation controls of the picture information, location information of the operation controls on the thumbnail picture being the same as location information of the operation controls on the picture information;

wherein the generating module is further operative to generate a projected picture based on the thumbnail picture.

17. The apparatus of clause 10, wherein the control operation comprises at least one of:

a touch operation, a body sensing operation, a gesture operation, and a voice operation.

18. The apparatus of one of the clauses 10 to 17, wherein the controlled device is a smart television, a television set top box, a personal computer, or a projector.

19. A mobile terminal, the mobile terminal comprising a device control apparatus based on a mobile terminal of one of the clauses 10 to 18.

What is claimed is:

1. A method comprising:
establishing a communication connection with a controlled device;
obtaining picture information currently displayed on the controlled device, and generating a projected picture based on the picture information;
receiving a control operation of a user targeting the projected picture; and
converting the control operation to an instruction recognizable by the controlled device, and transmitting the instruction to the controlled device, to control the controlled device.

2. The method of claim 1, wherein converting the control operation to an instruction recognizable by the controlled device comprises:
recognizing the control operation, and determining an operation instruction corresponding to the control operation;
determining an instruction mapping relationship corresponding to the picture information;
converting the operation instruction to an instruction recognizable by the controlled device based on the instruction mapping relationship.

3. The method of claim 2, wherein determining an instruction mapping relationship corresponding to the picture information comprises:
obtaining an identification of an application generating the picture information on the controlled device; and
querying a preset database based on the application identification, and obtaining a corresponding instruction mapping relationship.

4. The method of claim 1, further comprising:
determining an application setting corresponding to the picture information; and
controlling display parameters of the projected picture based on the application setting.

5. The method of claim 4, wherein the display parameters comprise smoothness and/or resolution.

6. The method of claim 1, wherein generating a projected picture based on the picture information comprises:
adjusting the size of the picture information based on the size of a preset display area, and generating the projected picture.

7. The method of claim 1, further comprising:
receiving a thumbnail picture transmitted by the controlled device, wherein the thumbnail picture includes operation controls of the picture information, location information of the operation controls on the thumbnail picture being the same as location information of the operation controls on the picture information; and
generating a projected picture based on the thumbnail picture.

8. The method of claim 1, wherein the control operation comprises at least one of:
a touch operation, a body sensing operation, a gesture operation, and a voice operation.

9. The method of claim 1, wherein the controlled device is a smart television, a television set top box, a personal computer, or a projector.

10. An apparatus comprising:
one or more processors;
memory;
a communication interface;
a display;
a communicating module stored in the memory and executable by the one or more processors to cause the communication interface to establish a communication connection with a controlled device;
an obtaining module stored in the memory and executable by the one or more processors to cause the communication interface to obtain picture information currently displayed on the controlled device;
a generating module stored in the memory and executable by the one or more processors to cause the one or more processors to generate a projected picture based on the picture information;
a first receiving module stored in the memory and executable by the one or more processors to cause the communication interface to receive a control operation of a user targeting the projected picture;
a converting module stored in the memory and executable by the one or more processors to cause the one or more processors to convert the control operation to an instruction recognizable by the controlled device; and
a transmitting module stored in the memory and executable by the one or more processors to cause the communication interface to transmit the instruction recognizable by the controlled device to the controlled device, to control the controlled device.

11. The apparatus of claim 10, wherein the converting module further comprises:
a recognizing unit stored in the memory and executable by the one or more processors to cause the one or more processors to recognize the control operation, and determine an operation instruction corresponding to the control operation;
a determining unit stored in the memory and executable by the one or more processors to cause the one or more processors to determine an instruction mapping relationship corresponding to the picture information; and
a converting unit stored in the memory and executable by the one or more processors to cause the one or more processors to convert the operation instruction to an instruction recognizable by the controlled device based on the instruction mapping relationship.

12. The apparatus of claim 11, wherein the determining unit is further executable by the one or more processors to cause the one or more processors to:
obtain an identification of an application generating the picture information on the controlled device; and
query a preset database based on the application identification, and obtain a corresponding instruction mapping relationship.

13. The apparatus of claim 10, further comprising:
a determining module stored in the memory and executable by the one or more processors to cause the one or more processors to determine an application setting corresponding to the picture information; and
a controlling module stored in the memory and executable by the one or more processors to cause the one or more processors to control display parameters of the projected picture based on the application setting.

14. The apparatus of claim 13, wherein the display parameters comprise smoothness and/or resolution.

15. The apparatus of claim 10, wherein the generating module is further operative to cause the one or more processors to:
adjust the size of the picture information based on the size of a preset display area, and generate the projected picture.

16. The apparatus of claim 10, further comprising:
a second receiving module stored in the memory and executable by the one or more processors to cause the communication interface to receive a thumbnail picture transmitted by the controlled device, wherein the thumbnail picture includes operation controls of the picture information, location information of the operation controls on the thumbnail picture being the same as location information of the operation controls on the picture information;
wherein the generating module is further executable by the one or more processors to cause the one or more processors to generate a projected picture based on the thumbnail picture.

17. The apparatus of claim 10, wherein the control operation comprises at least one of:
a touch operation, a body sensing operation, a gesture operation, and a voice operation.

18. The apparatus of claim 10, wherein the controlled device is a smart television, a television set top box, a personal computer, or a projector.

19. A mobile terminal, the mobile terminal comprising an apparatus of claim 10.

20. The mobile terminal of claim 19, wherein the apparatus further comprises:
a determining module stored in the memory and executable by the one or more processors to cause the one or more processors to determine an application setting corresponding to the picture information; and
a controlling module stored in the memory and executable by the one or more processors to cause the one or more processors to control display parameters of the projected picture based on the application setting
